(19) United States
(12) Patent Application Publication
(10) Pub. No.: US 2019/0105212 A1
(43) Pub. Date: Apr. 11, 2019

(54) MOLDABLE BACKBONE FOR POSITIONING DEVICE

(71) Applicant: KONINKLIJKE PHILIPS N.V, EINDHOVEN (NL)

(72) Inventors: Emile Johannes Karel VERSTEGEN, EINDHOVEN (NL); Vanessa SATTELE, EINDHOVEN (NL); Marjolein VAN LIESHOUT, WAARLE (NL)

(21) Appl. No.: 15/553,619

(22) PCT Filed: Feb. 19, 2016
(86) PCT No.: PCT/IB2016/050905

§ 371 Date: Aug. 25, 2017

Related U.S. Application Data
(60) Provisional application No. 62/135,349, filed on Mar. 19, 2015.

(51) Int. Cl. A61G 7/07; A61G 11/00; A47D 15/00; A47D 13/08; B29D 22/00; B29C 70/68

(52) U.S. Cl. CPC A61G 7/07; A61G 11/00; A47D 15/008; A47D 13/08; B29K 2083/00; B29C 70/68; A61G 2200/14; A61G 2200/327; B29D 22/003

(57) ABSTRACT

A support (10) for supporting a neonate is provided. The support (10) includes a body portion (12) including a shapeable material (16). The body portion (12) is configured for adjustment during use. A silicone layer (14) surrounds the body portion (12). The body portion (12) is (i) sufficiently pliable to enable adjustment thereof to conform to a shape of the neonate upon application of a stimulus (24) to the body portion (12), and (ii) sufficiently stiff to provide support for, and resist movements of, the neonate in the absence of the stimulus (24).

### FIELD

The following relates generally to supporting and holding a neonate, and to related arts such as the neonate incubator arts. However, it is to be understood that it also finds application in other usage scenarios and is not necessarily limited to the aforementioned application.

### BACKGROUND

Prematurely born neonates do not have the capability to position themselves in a comfortable position due to their underdeveloped proprioception and muscle strength. When neonates experience distress, they reflexively stretch their back and spread their arms, thereby adding to their discomfort. Once in this stressful position, the neonates are unable to reposition themselves back into a comfortable position.

Furthermore, neonates find containment to add to their comfort (i.e., by mimicking a womb) and such containment provides continuous pressure against their limbs to help muscle and bone formation. On the other hand, as many neonates have underdeveloped lungs and can depend on mechanical ventilation, it is important that their lungs inflate and deflate properly, and so the containment should not adversely impact neonate respiration.

Proper lung inflation, as well as comfortable lying and containment all start with proper positioning. Currently, neonates are properly positioned in a fetal posture, in which the hands are close to the face, the elbows are touching each other, the back is rounded, and the knees are lifted towards the chin. This posture should be emulated in side, prone, and supine positions.

The following provides new and improved methods and systems which overcome the above-referenced problems and others.

### BRIEF SUMMARY

It is recognized that known systems and methods of positioning a neonate have deficiencies. Conventionally, neonates in an incubator are contained and cushioned by suitably arranged pillow-type supports. However, movement of the neonate can move these supports out of position, leaving the neonate uncomfortable. Additionally, it has been found that relatively close containment of the neonate is beneficial as it simulates womb conditions and tends to comfort the neonate. On the other hand, since many neonates have underdeveloped lungs, sufficient room must be provided for respiration. Similar considerations arise in the context of carrier for transporting the neonate outside of the incubator.

Various improvements are disclosed herein.

In some illustrative embodiments, a disclosed neonate positioning device can employ a backbone made of a material that is sufficiently stiff to provide support and resist movements of the neonate, yet also sufficiently pliable to enable a user (i.e., a nurse) to adjust the backbone to conform with the specific neonate.

In some embodiments, the backbone is contemplated to be made of an elastomeric material that has the requisite balance between stiffness and flexibility. In other embodiments, the backbone is made of a material that becomes flexible upon application of slight heating. Some disclosed materials with this property comprise aliphatic compounds, especially those with melting points around 37-42° C. or so. Such compounds become soft upon application of slight warmth, such as that generated by a nurse holding the backbone. In such cases, the backbone may be shapeable by hand, even while in contact with the neonate. In other disclosed embodiments, an aliphatic compound with a higher melting point (e.g., 46-65° C.) may be used. In this case, it may not be possible to shape the backbone while contacting the neonate, but the shaping could be performed after heating with a hairdryer or other moderate source of warmth.

Aliphatic compounds with suitably low melting temperatures may have properties that are undesirable in a neonate support backbone, such as being in the form of an oil or fatty substance. To address this, structures have been developed in which the backbone has a containment bag, bladder, liner, or the like (for example, made of silicone and/or polyethylene) which is filled with cotton or another filler material providing desirable cushioning and into which an aliphatic oil is dispersed by soaking and/or capillary action. The resulting backbone is relatively pliable like a pillow, but has the desired stiffness at room temperature due to the aliphatic compound while being shapeable upon application of sufficient warmth.

In accordance with one aspect, a support for supporting a neonate is provided. The support includes a body portion including a shapeable material. The body portion is configured for adjustment during use. A silicone layer surrounds the body portion. The body portion is (i) sufficiently pliable to enable adjustment thereof to conform to a shape of the neonate upon application of a stimulus to the body portion, and (ii) sufficiently stiff to provide support for, and resist movements of, the neonate in the absence of the stimulus.

In accordance with another aspect, a method for making a support for supporting a neonate is provided. A bottom portion of a silicone layer is molded into a container-like shape. A body portion is placed into the container-like shape of the silicone layer. A heated aliphatic layer is poured over the body portion. The aliphatic layer is cooled. A top portion of the silicone layer is added over the body portion to seal the support.

In accordance with another aspect, a support for supporting a neonate is provided. The support includes a body portion that includes a shapeable material. The body portion is configured for adjustment during use. An aliphatic layer is disposed on at least a portion of the body portion. A silicone layer is disposed over the aliphatic layer. The body portion is: (i) sufficiently pliable to enable adjustment thereof to conform to a shape of the neonate upon application of thermal energy to at least one of the body portion and the aliphatic layer; and (ii) sufficiently stiff to provide support for, and resist movements of, the neonate in the absence of the thermal energy.

One advantage resides in providing a support for a neonate that is made from a single unit.

Another advantage resides in providing a support for a neonate that can be manipulated with an external stimulus applied to the support.

Another advantage resides in providing a support for a neonate that encourages healthy neonate bone and muscle growth.

Still further advantages of the present disclosure will be appreciated to those of ordinary skill in the art upon reading and understanding the following detailed description.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the present disclosure.

FIG. 1 shows a support for a neonate in one embodiment of the present disclosure.

FIG. 2 shows a shaped version of the support of FIG. 1.

FIG. 3 shows an example use flow chart for manufacturing the support of FIGS. 1 and 2.

FIGS. 4A-F show exemplary steps of the process of FIG. 3 for producing the support of FIGS. 1 and 2.

### DETAILED DESCRIPTION

Ideally, positioning of a neonate should be done with one support that can solve numerous positioning needs. For example, the support should be able to take on various shapes according to the size and needs of the neonate. The support should provide resistance to deformation, caused by motion (e.g. kicking hands and feet, and the like) of the neonate. In some illustrative embodiments, the support is made from one or more materials that can be shaped in an easy way and then frozen in a desired shape during use, suiting the needs of the neonate. A support body suitably has a skeleton made of such material. An outside layer may be cotton or another skin-friendly material.

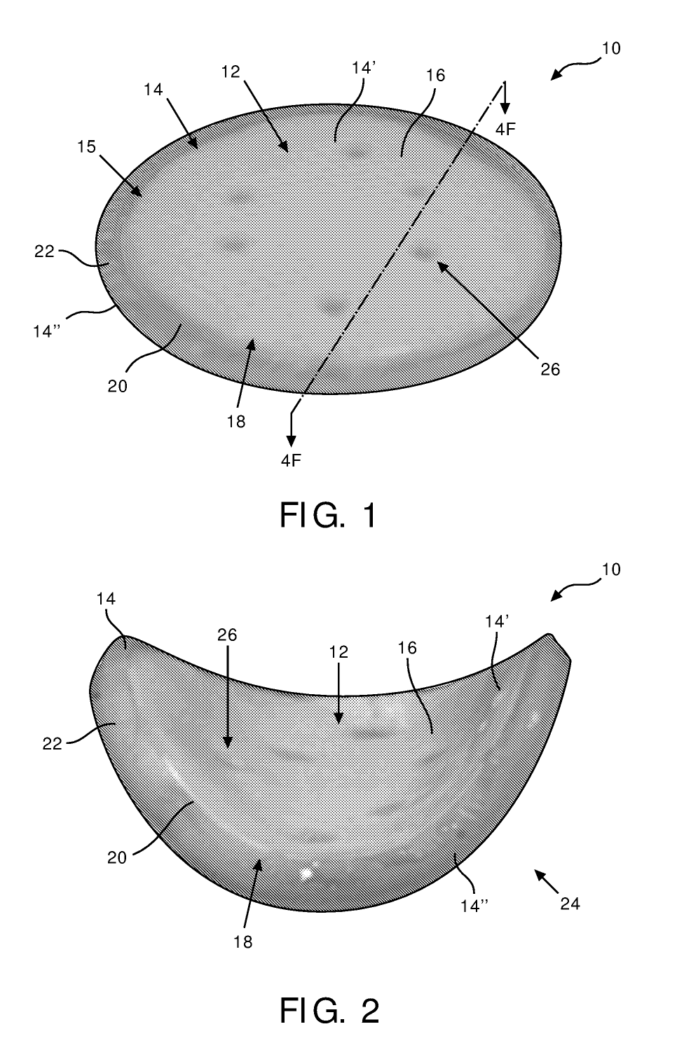

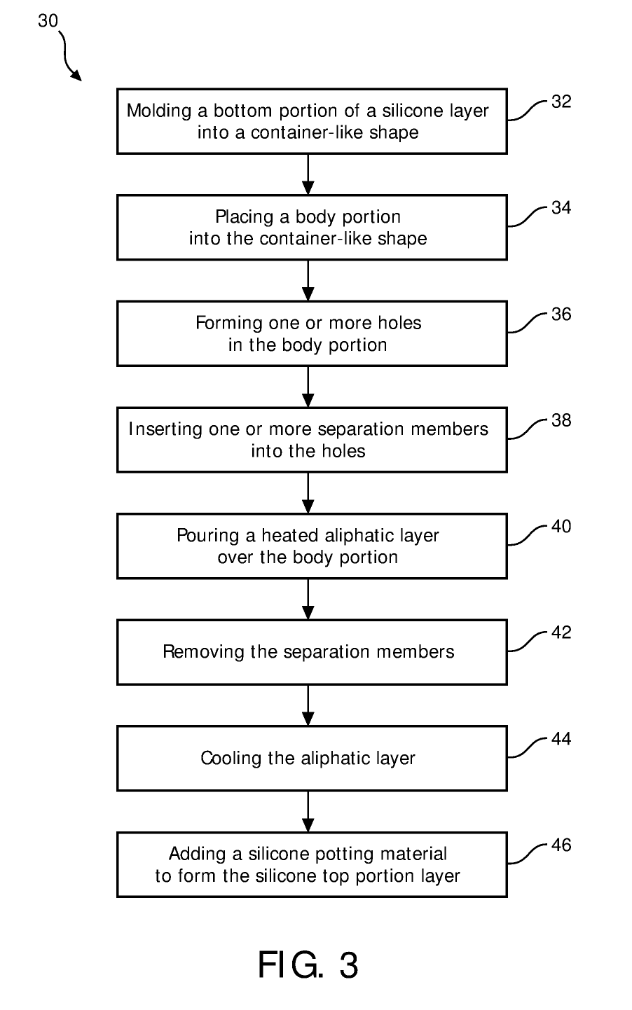

Supports disclosed herein are shapeable upon application of a stimulus thereto. With reference to FIG. 1, a support 10 for supporting a neonate is formed. It will be appreciated that the support 10 can be used to support a target tissues, body parts, or anatomical portions of the neonate (e.g., the head, the neck, the torso, and the like) or multiple target tissues, body parts, or anatomical portions of the neonate (e.g., the head, the neck, the torso, the arms, the legs, and the like). Moreover, as used herein, the term “target tissue” refers to any desired target tissue, body parts, or anatomical portions (e.g., the head, the neck, the torso, the arms, the legs, and the like) of a neonate. As shown in FIG. 1, the support 10 includes a body portion 12 and a silicone layer or container 14. A neonate (not shown) can be positioned on the support 10. The body portion 12 can have any geometry (e.g., circular, rectangular, square, and the like) and can be shaped into a desired shape for holding and supporting a neonate (i.e., like a “divot”). The illustrative support 10 has a disk geometry, and FIG. 1 shows the disk in a flat (or planar) configuration. Advantageously, the body portion 12 is configured for adjustment during use, as described in more detail below (see, e.g. FIG. 2 where the disk is shaped into a curved geometry).

In some example embodiments, the body portion 12 is made from a shapeable material 16. In some embodiments, the shapeable material includes an aliphatic compound (also known as a non-aromatic compound). As understood by one of skill in the art, aliphatic compounds are organic compounds that do not include aromatic rings. In an aliphatic compound, the carbon atoms usually form straight or branched chains, or “looser” ring structures as compared with aromatic rings. Thus, aliphatic solids tend to be shapeable, and typically exhibit relatively low melting points. Some illustrative relatively soft aliphatic solids include certain elastomers, resins, waxes, fats, and emulsifiers. Elastomers provide elasticity or bounce for the body portion 12, and can be a natural latex, such as couma macrocarpa (i.e., leche caspi or sorva latex), loquat (i.e., nispero), tunu, jelutong, chicle, or a synthetic rubber (e.g. styrene-butadiene rubber, butyl rubber, polyisobutylene). Resins may be incorporated to provide a cohesive body or strength for the body portion 12. Some suitable resins include glycerol esters of gum, terpene resins, and/or polyvinyl acetate. The body portion 12 may further include a wax, which acts as a softening agent for the body portion 12. Some suitable waxes include paraffin or microcrystalline wax. A fat material may be included—fats behave as plasticizers for the body portion 12, and can be hydrogenated vegetable oils. An emulsifier may be added to aid with hydration for the body portion 12, and can be lecithin or glycerol monostearate. Various combinations of one or more of an elastomer, resin, wax, fat, or emulsifier may be used to provide a composite with desired properties. Fillers may also be provided to impart texture for the body portion 12, and can for example be calcium carbonate or talc. The shapeable material 16 of the body portion 12 is designed to be: (i) sufficiently pliable to enable adjustment thereof to conform to a shape of the neonate upon application of a stimulus to the body portion 12; and (ii) sufficiently stiff to provide support for, and resist movements of, the neonate in the absence of the stimulus. In addition, the body portion 12 has a stiffness to provide pressure against the neonate, thereby facilitating bone and muscle growth of the neonate.

In some embodiments, the silicone layer 14 partially surrounds a portion of the body portion 12. In other examples, the silicone layer 14 is a container that completely surrounds the body portion 12. In some embodiments, the silicone layer 14 is a container that encapsulates the body portion 12 to prevent leakage of the (typically soft, or semi-solid) shapeable material 16. To do so, the silicone layer 14 is made from a silicone material (e.g., medical grade silicone, hydroxyl-terminated silicone cured with boric acid, and the like) that is has a low degree of hardness (e.g., 0-10 Shore hardness). Stated another way, the silicone layer 14 is soft. The silicone layer 14 is transparent or translucent so as to reveal an interior thereof. In some instances, the silicone layer 14 includes a top portion 14′ and a bottom portion 14″. For example, the bottom portion 14″ can be formed to a container-like shape (e.g., a box-like shape, a bowl-like shape, and the like). The body portion 12 is inserted into the container-like shape of the bottom portion 14″, and the top portion 14′ is positioned over the body portion 12 to “close off the container” and seal the support 10. Once the silicone layer 14 is positioned about the body portion 12, the support 10 is cured. The degree of curing determines the rigidity of the silicone layer 14.

In some embodiments, a barrier layer 15 is disposed between the shapeable material 16 and the silicone layer 14. The barrier layer 15 is provided to prevent diffusion of the shapeable material 16 to the silicone layer 14. The barrier 15 is composed of a suitable packaging material, such as polyethyleneterephthalate (PET). In some examples, a bag of polyethyleneterephthalate can be used to make the barrier layer 15. This bag can be filled with the shapeable material 16 and sealed. The resulting bag is immersed in the silicone layer 14, which is held in place in a mold followed be curing of the silicone layer 14.

With reference to FIG. 2, shapeability of the support 10 is illustrated. As previously mentioned, FIG. 1 shows the illustrative support 10 in a flat, planar shape. FIG. 2 shows the support 10 shaped to have a concave surface (facing generally upward in illustrative FIG. 2) and an opposite concave surface (not visible from the vantage of FIG. 2). The shapeable material 16 includes an aliphatic layer 18 disposed on at least a portion of the body portion 12. In some examples, the aliphatic layer 18 is disposed on a selected portion of the body portion 12. In other examples, the aliphatic layer 18 completely surrounds the body portion 12. Advantageously, the aliphatic layer 18 is shapeable upon application of an external stimulus, as described in more detail below.

The aliphatic layer 18 is made from an aliphatic compound 20. As known to one of skill in the art, aliphatic compounds become shapeable when a force or stimulus is applied thereto (e.g., warmth). Thus, the aliphatic compound 20 can be warmed, shaped into a desired shape, and then cooled to maintain the desired shape. In some embodiments, the aliphatic compound 20 is selected from a group of compounds including nonadecane, icosane, heneicosane, docosane, tricosane, pentacosane, and triacontane. Table 1 provides the chemical formula and melting temperature of each of these illustrative aliphatic compounds 20. These are merely illustrative examples, and other aliphatic compounds, or other materials with desired shapeability properties, are also contemplated.

TABLE 1
aliphatic compounds, their chemical formulas and melting points

| Name | Formula | Melting point (Tm) |
|---|---|---|
| Nonadecane | C₁₉H₄₀ | mp~33°C. |
| Icosane | C₂₀H₄₂ | mp~37°C. |
| Heneicosane | C₂₁H₄₄ | mp~40°C. |
| Docosane | C₂₂H₄₆ | mp~42°C. |
| Tricosane | C₂₃H₄₈ | mp~46°C. |
| Pentacosane | C₂₅H₅₂ | mp~54°C. |
| Triacontane | C₃₀₁₄₆₂ | mp~65°C. |

As can be discerned from Table 1, the melting temperature of the aliphatic compound 20 typically increases as the length of the molecule increases. In one example, icosane has a melting point of 37° C., thereby allowing a user to warm the icosane aliphatic layer 18 by hand (i.e., ambient body heat) and shape the body portion 12 into a desired shape to hold the neonate, even while the neonate is positioned on the support 10. In another example, docosane has a higher melting point of 42° C., thereby allowing a user to warm the aliphatic layer 18 with a small, easily-available heating unit (e.g., a blow dryer, a space heater, and the like) and shape the body portion 12 into a desired shape to hold the neonate, even while the neonate is positioned on the support 10. More generally, in some embodiments the aliphatic compound has a melting point in the range 30° C.-70° C. inclusive, so that holds its shape at room temperature (suitably defined as 20° C.-27° C. inclusive, and more typically 20° C.-25° C.) and becomes shapeable upon application of thermal energy. It should be noted that the applied thermal energy does not necessarily need to heat the aliphatic compound above its melting point, as the aliphatic compound may become soft and deformable at a temperature close to, but still below, its melting point.

The aliphatic compound 20 may have properties that are undesirable, such as being in the form of an oil or fatty substance. To address this, the silicone layer 14 is configured as a containment bag, bladder, liner, or the like. The aliphatic layer 18 is embedded within or contained inside the silicone layer 14. Stated another way, the silicone layer 14 is disposed over (i.e., surrounds) the aliphatic layer 18. In some embodiments, the body portion 12 is configured to absorb oily/fatty byproducts of the aliphatic layer 18 (e.g., by soaking, capillary action, and the like).

In some embodiments, a potting material layer 22 can be inserted into a portion of the support 10. As shown in FIG. 2, the potting material layer 22 is disposed within the silicone layer 14. It will be appreciated that the potting material layer 22 can be disposed on any suitable portion of the support 10 (e.g., within the body portion 12, between the body portion 12 and the silicone layer 14, between the aliphatic layer 18 and the body portion 12, between the aliphatic layer 18 and the silicone layer 14, and the like). The potting material layer 22 can be cotton (or another filler material) to provide desirable cushioning and into which an oil/fatty byproduct of the aliphatic layer 18 is dispersed by soaking and/or capillary action.

Advantageously, the support 10 is shaped into a desired shape upon application of an external stimulus 24 thereto. Examples of the stimulus 24 can be: mechanical energy (i.e., movement), thermal energy (e.g., crystallization, melting phenomena, and the like), light, and electrical energy. The type of stimulus 24 used depends on a variety of factors. For example, the selected type of stimulus 24 depends on: (1) the material(s) chosen to produce the support 10; (2) access to an incubator in which the neonate is held; (3) any presence of electrical cables or tubes; (4) absence of metals because of use of x-ray machines; or (5) complexity in general.

In some examples, a mechanical external stimulus 24 is applied to the support 10. In this example, the shapeable material 16 and the aliphatic layer 18 are deformed with limited effort, but still exhibit enough rigidity to withstand neonatal weight and neonatal movements. In other examples, a thermal (hereinafter, “warmth”) external stimulus 24 is applied to the support 10. For example, the shapeable material 16 can be coated with the aliphatic layer 18, shaped into a desired shape with warmth (e.g., from body heat or an external heat source) until the aliphatic layer 18 is slightly below, at, or above the melting point of the aliphatic compound 20, and then left in room temperature to “freeze” (i.e., cooled below the melting point of the aliphatic compound 20), thereby allowing the body portion 12 to settle into the desired shape.

In other embodiments, one or more holes 26 can be formed into the body portion 12. Advantageously, the holes 26 bridge a top portion (i.e., a top surface) of the silicone layer 14 and a bottom portion (i.e., a bottom surface) of the silicone layer 14, thereby allowing the aliphatic layer 18 to penetrate into the body portion 12. To separate the top and bottom portions of the silicone layer 14, one or more separation members 28 are placed into the holes 26. The separation members 28 contact each of the top and bottom portions of the silicone layer 14 to provide a separation therebetween. In some examples, the separation members 28 can be rods; however, it will be appreciated that the separation members 28 can have any suitable configuration to separate the top and bottom portions of the silicone layer 14. Advantageously, the separation members 28 limit access of the aliphatic layer 18 to the bottom portion of the silicone layer 14.

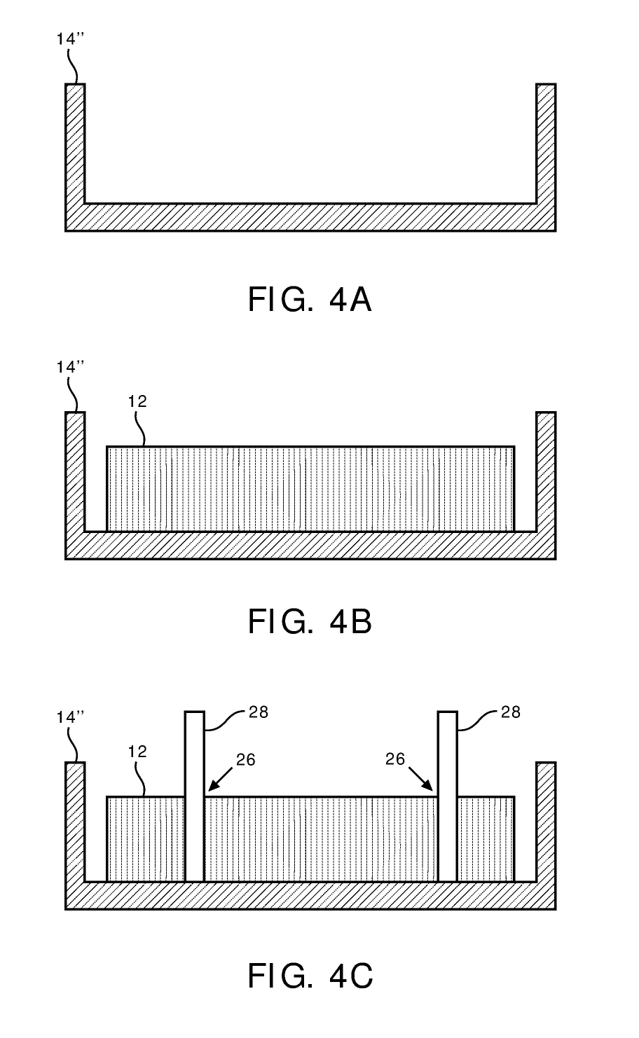

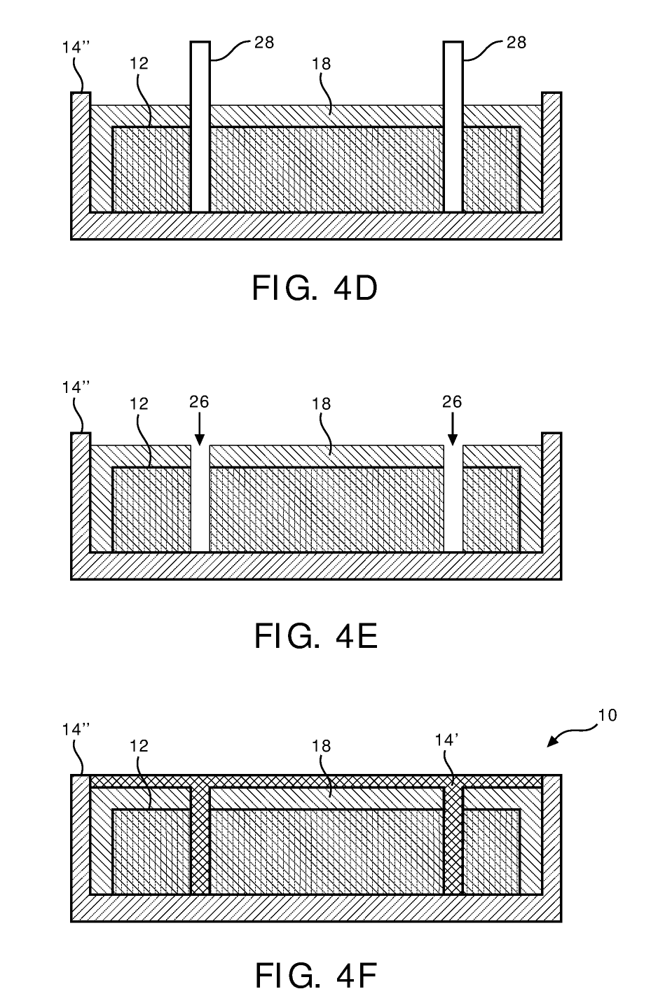

With reference to FIG. 3 and to FIGS. 4A-4F, an example method 30 of making the support 10 is diagrammatically shown. The method 30 includes the steps of: molding a bottom portion 14″ of the silicone layer 14 into a container-like shape, as shown in FIG. 4A (Step 32); placing a body portion 12 into the container-like shape of the silicone layer bottom portion 14″, as shown in FIG. 4B (Step 34); forming one or more holes 26 in the body portion 12 to bridge between the top portion 14′ of the silicone layer 14 and the bottom portion 14″ of the silicone layer 14 (Step 36); inserting one or more separation members 28 into the holes 26 for limiting access of the aliphatic layer 18 to the bottom silicone layer 14 surface, as shown in FIG. 4C (Step 38); pouring a heated aliphatic layer 18 over the body portion 12, as shown in FIG. 4D (Step 40); removing the separation members 28, as shown in FIG. 4E (Step 42); cooling the aliphatic layer 18 (Step 44); and adding a potting material 22 that fills the openings 26 and forms the top portion 14′ of the silicone container 14 as shown in FIG. 4F (Step 46).

It is to be appreciated that the foregoing are merely illustrative examples, and numerous variants are contemplated. The container may be made of another flexible material other than silicone, such another curable polymer. Various meshes, granulated materials, or so forth can be employed as the body portion, or in some embodiments the body portion is omitted entirely. While the illustrative example is a disk-shaped generally planar support, in other embodiments the support may be otherwise shaped. It is contemplated to add an outer cloth jacket or other suitable outer layer to improve comfort at contact with the neonate. While in the illustrative fabrication process the container is sealed by potting the top portion 14′, other approaches are contemplated, such as providing a pre-molded top portion that is attached to the bottom portion by adhesive, heat-tacking or the like.

The invention has been described with reference to the preferred embodiments. Modifications and alterations may occur to others upon reading and understanding the preceding detailed description. It is intended that the invention be constructed as including all such modifications and alterations as they come within the scope of the appended claims or the equivalents thereof.

1. A support for supporting a neonate, the support comprising:
a body portion including a shapeable material, the body portion being configured for adjustment during use; and
a container surrounding the body portion;
wherein the body portion is:
(i) sufficiently pliable to enable adjustment thereof to conform to a shape of the neonate upon application of a stimulus to the body portion; and
(ii) sufficiently stiff to provide support for, and resist movements of, the neonate in the absence of the stimulus.

2. The support according to claim 1, further including an aliphatic layer disposed on at least a portion of the body portion, the aliphatic layer having a melting point of between 30° C. and 70° C. inclusive.

3. The support according to claim 2, wherein the aliphatic layer is shapeable upon the application of the stimulus comprising heating above the melting point of the aliphatic layer.

4. The support according to claim 2, wherein the aliphatic layer comprises at least one of nonadecane, icosane, heneicosane, docosane, tricosane, pentacosane, and triacontane.

5. The support according to claim 2, wherein aliphatic layer comprises at least one of icosane and docosane.

6. The support according to claim 1, wherein the shapeable material is selected from a group comprising: one or more elastomers, one or more resins, one or more waxes, one or more fats, one or more emulsifiers, and one or more fillers.

7. The support according to claim 1, wherein the stimulus comprises a mechanical force.

8. The support according to claim 1, wherein the stimulus comprises thermal energy.

9. The support according to claim 1, further including a potting material layer disposed within the silicone layer.

10. The support according to claim 1, further including a barrier layer disposed between the shapeable material and the silicone layer.

11. A method for making a support for supporting a neonate, the method comprising:
molding a bottom portion of a silicone layer into a container;
placing a body portion into the container;
pouring a heated aliphatic layer over the body portion;
cooling the aliphatic layer; and
adding a top portion of the silicone layer over the body portion to seal the support.

12. The method according to claim 11, further including:
forming one or more holes in the body portion to bridge the top silicone portion surface and the bottom silicone portion surface prior to pouring the aliphatic layer.

13. The method according to claim 12, further including:
inserting one or more separation members into the holes for limiting access of the aliphatic layer to the bottom silicone layer surface; and
removing the separation members before the aliphatic layer is poured.

14. The method according to claim 11, further including:
heating the aliphatic layer to a temperature greater than a melting temperature thereof prior to pouring the aliphatic layer on to the body portion.

15. The method according to claim 11, further including:
cooling the aliphatic layer to a temperature lower than the melting temperature thereof after pouring the aliphatic layer onto the body portion.

16. The method according to claim 11, wherein adding a top portion of the silicone layer comprises:
potting the body portion and the aliphatic layer with silicone potting material.

17. A support for supporting a neonate, the support comprising:
a body portion including a shapeable material, the body portion being configured for adjustment during use;
an aliphatic compound disposed on at least a portion of the body portion;
a flexible container containing the body portion and the aliphatic compound;
wherein the body portion is:
(i) sufficiently pliable to enable adjustment thereof to conform to a shape of the neonate upon application of thermal energy to at least one of the body portion and the aliphatic compound; and
(ii) sufficiently stiff to provide support for, and resist movements of, the neonate in the absence of the thermal energy.

18. The support according to claim 17, wherein the aliphatic compound has a melting point between 30° C.-70° C. inclusive and is shapeable upon the application of the thermal energy.

19. The support according to claim 17, wherein the aliphatic compound includes at least one of nonadecane, icosane, heneicosane, docosane, tricosane, pentacosane, and triacontane.

20. The support according to claim 17, wherein aliphatic compound includes at least one of icosane and docosane.

21. (canceled)
